(19) United States
(12) Patent Application Publication
(10) Pub. No.: US 2025/0050561 A1
(43) Pub. Date: Feb. 13, 2025

(54) CO-INJECTION MOLDING STRUCTURE

(71) Applicant: RAYSPERT PRECISION INDUSTRIAL INC, Tainan (TW)

(72) Inventor: Shun-Fu Lin, Tainan (TW)

(21) Appl. No.: 18/232,328

(22) Filed: Aug. 9, 2023

(51) Int. Cl. B29C 45/23; B29C 45/18; B29C 45/34

(52) U.S. Cl. CPC B29C 45/231; B29C 45/1866; B29C 45/34; B33Y 80/00

(57) ABSTRACT

Provided is a co-injection molding structure, mainly including a co-injection molding device and a molding die. The co-injection molding device includes a valve needle displaceable in a cylinder block. The valve needle is provided with a channel a first valve and a second valve. The channel communicates with a first feed tube and a second feed tube. The cylinder block communicates with a mold cavity of a molding die and the channel. When the valve needle is in a first position, the second valve will close the second feed tube such that a first material is injected into the mold cavity. When the valve needle is in a second position, the first valve will close the first feed tube such that a second material is injected into the mold cavity and covered by the first material, thereby filling an end of the mold cavity.

### BACKGROUND OF THE INVENTION

### 1. Field of the Invention

The present disclosure relates to an injection molding structure, especially a co-injection molding structure.

### 2. The Prior Arts

In our daily life, we can see the existence of plastic products everywhere, and the most common production method of plastic products is injection molding. In addition to the above, conventional injection molding has also been continuously improved, that is, the performance, applicability and yield of the injection molding process are improved, and co-injection molding is the product born under this. The feature of co-injection molding is that two kinds of the same or different plastic materials or resins of different colors are filled into a mold cavity indirectly/continuously through the same runner such that a finished product becomes a structure in which an outer layer covers an inner layer.

In the existing co-injection molding structure, two independently controllable injection machines are respectively connected to the runner of the mold, and the time and sequence of injecting and filling of the materials in each of the injection machines into the mold cavity are controlled separately. However, each independent injection machine needs to occupy a large amount of space, and the structure and individual operation control thereof are also complicated.

Further, the feature of co-injection molding is that the outer layer material can be used to cover the inner layer material. First, the outer layer material is injected into the mold cavity, and the molten material solidifies after contacting the mold wall to slowly form the outer layer, while the center of the outer material remains molten. Subsequently, when the inner layer material is injected, the inner layer material flows inside the outer layer material whose surface has solidified, and the uncured outer material is pushed towards the end of the mold cavity until it is filled. Since material properties (e.g., melting point, viscosity and fluidity) must be considered, the mold needs to be heated to a preset temperature to allow the outer material to maintain its fluidity in the mold cavity. In addition, after the outer layer material enters the mold cavity, the temperature of the mold is lowered to allow the surface of the outer layer to gradually solidify and harden such that when the inner layer material is injected into the outer layer material, the inner layer material will not break through the outer layer. However, since the temperature of the mold need to be heated and cooled rapidly, it consumes a lot of energy, the process takes a long time, and the surface of the finished will also have flow marks and be unsightly. These are the most common problems in the co-injection process.

### SUMMARY OF THE INVENTION

In view of the shortcomings and deficiencies of the prior art, the main objective of the present disclosure is to improve the lack of existing structures. Another objective of the present disclosure is to solve the problems of energy consumption, long process time and flow marks on a surface of a finished product.

In order to achieve the above-mentioned objective, the technical means adopted in the present disclosure is a co-injection molding structure, including: a co-injection molding device, including a cylinder block, a valve needle, a first feed tube and a second feed tube, wherein an accommodating space is arranged axially inside the cylinder block, the accommodating space communicates with the outside with a first runner, a second runner and a nozzle, the valve needle is arranged in the accommodating space and is operable to reciprocate between a first position and a second position in an axial direction of the cylinder block, a channel is arranged in the axial direction of the valve needle to communicate with the nozzle, the valve needle is provided with a first opening corresponding to the first runner, a second opening corresponding to the second runner, a first valve and a second valve, the inside of the first feed tube is used to contain a first material and communicates with the first runner, the inside of the second feed tube is used to contain a second material and communicate with the second runner; and a molding die, including a first mold and a second mold operable to be coupled or separated, wherein the first mold is coupled to the second mold to form a mold cavity, and the mold cavity has a sprue connected to the nozzle of the co-injection molding device, whereby when the valve needle is in the first position, the second valve closes the second runner, and the first material of the first feed tube enters the channel through the first runner and the first opening and is injected into the mold cavity by the nozzle; when the valve needle is displaced from the first position to the second position, the first valve closes the first runner, and the second material of the second feed tube enters the channel through the second runner and the second opening, is injected into the mold cavity by the nozzle, is covered by the first material, and pushes the first material to flow to an end of the mold cavity.

In one embodiment, a mold core is embedded in the mold cavity, the mold core is made of porous metal such that the inside of the mold core is covered with connected micropores, a conformal air duct is provided inside the mold core, the conformal air duct is connected with the micropores of the mold core, the conformal air duct is arranged around the mold cavity at intervals according to a shape of the mold cavity, the conformal air duct communicates with a pneumatic control device, and the pneumatic control device controls a gas to enter from the conformal air duct and diffuses to the mold cavity through the micropores of the mold core, or controls the gas in the mold cavity to be discharged from the micropores of the more core through the conformal air duct to the outside through the conformal air duct.

In one embodiment, after the first material enters the mold cavity, the pneumatic control device controls the gas to diffuse out through the conformal air duct and the micropores of the mold core such that a surface of the first material is cooled to form an epidermal layer, and after the second material enters the mold cavity, the pneumatic control device control an exhaust gas of the mold cavity such that the flowing first material and the flowing second material are filled to an end of the mold cavity by the gravity of the exhaust gas.

In one embodiment, the conformal air duct has a main air duct and a plurality of secondary air ducts, the main air duct is arranged around the mold cavity at an interval, and each of the secondary air ducts is connected at intervals between the mold cavity and the main air duct.

In one embodiment, the porous metal is formed by 3D printing.

In one embodiment, the second material is a foaming material, and the pneumatic control device is operable to make a speed of the exhaust gas consistent with a foaming speed of the foaming material such that the second material is foamed completely.

In one embodiment, the cylinder block and the valve needle of the co-injection molding device are arranged inside the molding die, and the first feed tube and the second feed tube are arranged outside the molding die.

In one embodiment, the cylinder block is provided with a heater, which is used to keep an interior of the cylinder block at a preset temperature, so as to maintain fluidity of the first material and the second material.

With the aforesaid structure, the present disclosure not only solves the problem of complicated structure and operation control, but also uses a gas to adjust the temperature of the mold cavity and the flow direction and speed of the first material and the second material so as to solve the problems of energy consumption and long process time, while reducing the phenomenon of flow marks and unsightly appearance on the surface of the finished product.

### BRIEF DESCRIPTION OF THE DRAWINGS

FIG. 1 is a schematic diagram showing a valve needle of the present disclosure in a first position.

FIG. 2 is a schematic diagram showing the valve needle of the present disclosure in a second position.

FIGS. 3, 4 and 5 are sequential schematic diagrams showing the injection of a first material and a second material into a mold cavity according to the present disclosure.

FIG. 6 is a schematic diagram showing a molding die according to an embodiment of the present disclosure.

FIG. 7 is a schematic diagram showing an embodiment of the present disclosure.

### DETAILED DESCRIPTION OF THE PREFERRED EMBODIMENT

The following is a specific embodiment to illustrate the implementation of the present disclosure. Persons skilled in the art can easily understand the other advantages and effects of the present disclosure from the disclosure in the specification.

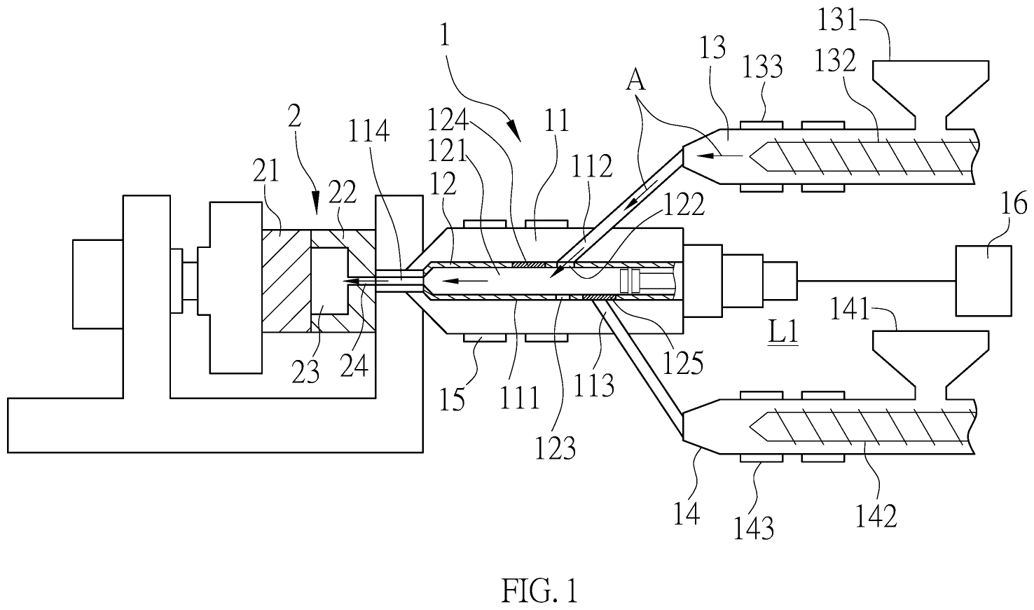

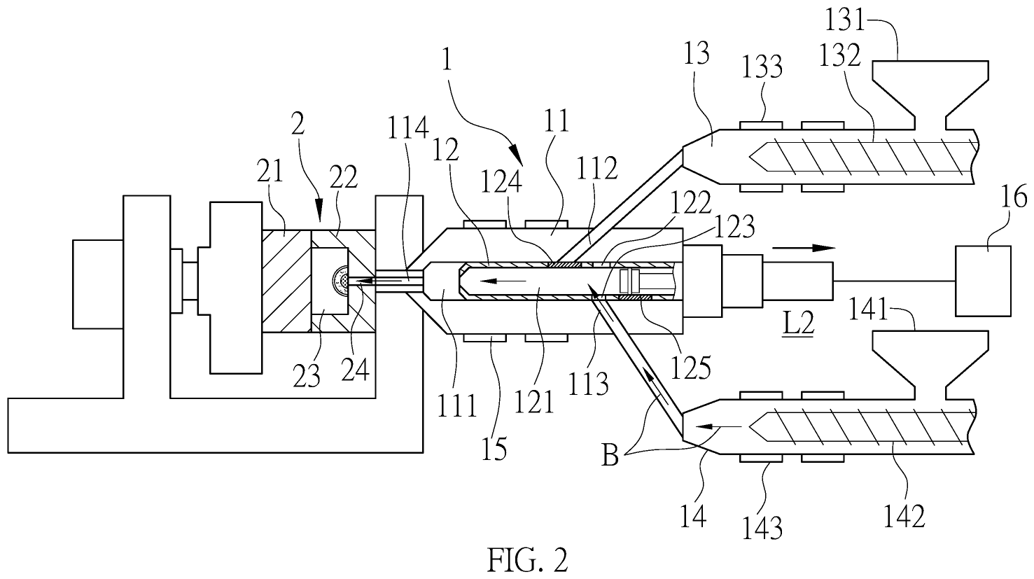

As shown in FIG. 1 and FIG. 2, a co-injection molding structure in a preferred embodiment of the present disclosure mainly includes a co-injection molding device 1 and a molding die 2.

The co-injection molding device 1 includes a cylinder block 11, a valve needle 12, a first feed tube 13 and a second feed tube 14. An accommodating space 111 is arranged axially inside the cylinder block 11. The accommodating space 111 communicates with the outside with a first runner 112, a second runner 113 and a nozzle 114. The nozzle 114 is located at the front end of the cylinder 11, and the first runner 112 and the second runner 113 are preferably located in the middle and rear section of the cylinder block 11. Additionally, the outer edge of the cylinder block 11 is provided with a heater 15, which is used to keep the inside of the cylinder block 11 at a preset temperature so as to ensure the fluidity of the internal material.

The valve needle 12 is located in the accommodating space 111 and is operated by a power device 16 to reciprocate between a first position L1 and a second position L2 in the axial direction of the cylinder block 11. The valve needle 12 is axially provided with a channel 121 connected to the nozzle 114 of the cylinder block 11. In addition, the valve needle 12 is provided with a first opening 122 corresponding to the first runner 112, a second opening 123 corresponding to the second runner 113, a first valve 124 and a second valve 125. The first opening 122 and the second opening 123 correspond to or are dislocated between the first runner 112 and the second runner 113 as the valve needle 12 moves.

One end of the first feed tube 13 is connected to the first runner 112, and the other end thereof is provided with a first hopper 131 which can be communicate with the inside of the first feed tube 13. A first material A can be poured from the first hopper 1331, and a first pushing mechanism 132 is provided inside the first feed tube 13 to push the first material A to the first runner 112. Besides, the first feed tube 13 is further provided with a first heater 133 so as to heat the first material A into a fluid state. The first material A may be a general-purpose injection plastic, such as polyethylene (PE), polystyrene (PS), polypropylene (PP), polycarbonate (PC), etc. or a combination thereof.

One end of the second feed tube 14 is connected to the second runner 113, and the other end thereof is provided with a second hopper 141 which can communicate with the inside of the second feed tube 14. A second material B can be poured from the second hopper 141, and a second pushing mechanism 142 is provided inside the second feed tube 14 to push the second material B to the second runner 112. Besides, the second feed tube 14 is further provided with a second heater 143 so as to heat the second material B into a fluid state. The second material B may be the same as or different from the first material A, and may be recycled secondary plastics or foamed materials, such as foamed polyurethane (PU), expanded polystyrene (EPS), polyvinyl chloride (PVC), expanded polyethylene (EPE), expanded polypropylene (EPP), etc. or a combination thereof.

The molding die 2 includes a first mold 21 and a second mold 22 which are operably coupled or separated. The first mold 21 is matched with the second mold 22 to form a mold cavity 23, and the mold cavity 23 has a sprue 24 connected to the nozzle 114 of the co-injection molding device 1.

With the aforementioned structure, when the valve needle 12 is at the first position L1, the second valve 125 will close the second runner 113 such that the first material A in the first feed tube 13 enters the channel 121 from the first opening 122 and is injected into the mold cavity 23 by the nozzle 114. Subsequently, the valve needle 12 is controlled to move from the first position L1 to the second position L2 such that the first valve 124 closes the first runner 112. In addition, the second material B in the second feed tube 14 enters the channel 121 from the second opening 123 and is injected into the mold cavity 23 by the nozzle 114. Consequently, the second material B is covered by the first material A and pushes the first material A to flow to the end of the mold cavity 23.

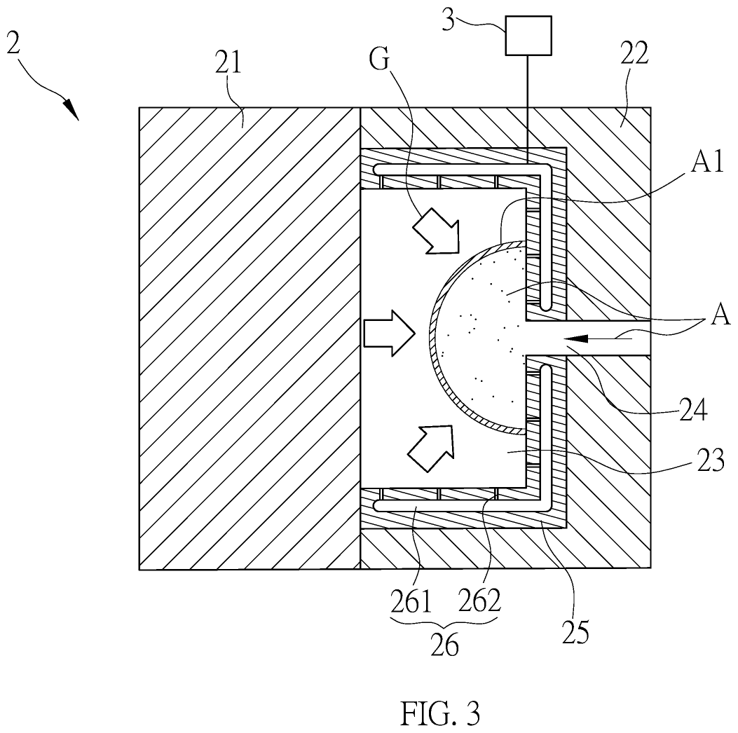

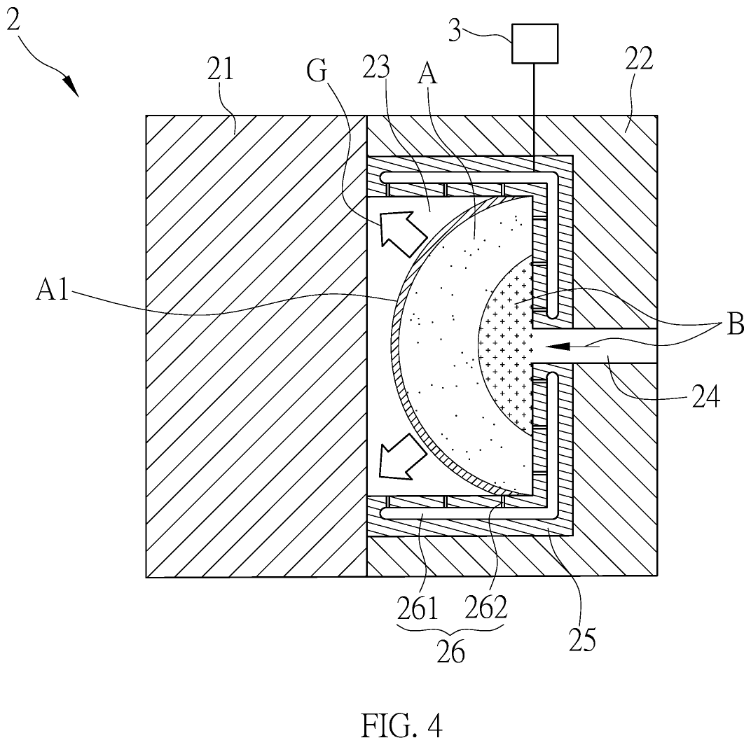

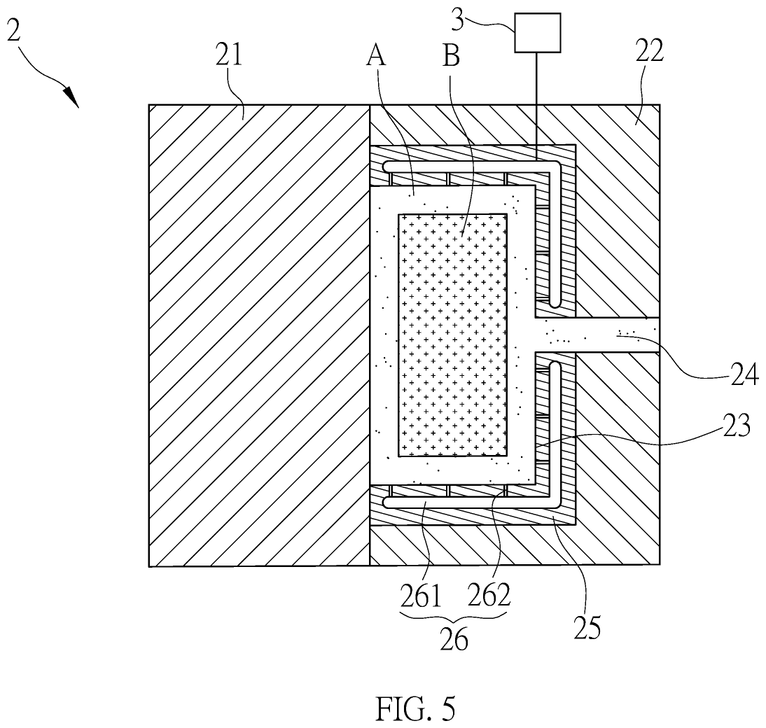

Please continue to refer to FIG. 3 to FIG. 5, a mold core 25 is inlaid in the mold cavity 23. In the drawings of this embodiment, the mold core 25 may be arranged in the second mold 22, but not limited thereto, and the mold core 25 may also be inlaid in the first mold 21. The present disclosure does not limit the quantity of the mold core 23, and FIG. 3 takes a mold core as an example for illustration. The mold core 25 may be made of porous metal such that the inside of the mold core 25 is evenly covered with connected micropores. The micropores are preferably formed by 3D printing, and 3D printing will also make the mold core 25 naturally covered with micropores, which are not shown in the drawings of the present disclosure. The mold core 25 is internally provided with a conformal air duct 26, which communicates with the micropores of the mold core 25. The conformal air duct 26 has at least one main air duct 261 and a plurality of secondary air ducts 262. The main air duct 261 is arranged around the mold cavity 23 at an interval along with the shape of the mold cavity 23, and each of the secondary air ducts 262 is connected at interval between the mold cavity 23 and the main air duct 261. Further, the conformal air duct 26 communicates with an external pneumatic control device 3. The pneumatic control device 3 controls the gas G to enter the mold cavity 23 from the conformal air duct 26 and diffuses the gas G to the mold cavity 23. Alternatively, the pneumatic control device 3 controls the gas G to be discharged from the mold cavity 23 through the micropores of the mold core 25 and the conformal air duct 26. The temperature of the gas G may be changed depending on material properties and requirements.

The following content will specifically illustrate the state and program of the actual action of the present disclosure, and the programs and action cycles can be assembled into an automatic sequence and controlled by a control unit. The control unit is used in many aspects and is not within the scope of the present disclosure. Accordingly, the features thereof are not described in detail. A shown in FIG. 3 to FIG. 5, when the present disclosure actually operates, the first mold 21 is matched with the second mold 22, and the valve needle 12 is controlled to be located at the first position L1. Simultaneously, the second valve 125 closes the second runner 113. The first heater 133 heats the first material A in the first feed tube 13 such that the first material A is in a fluid state, pushing the flowing first material A to the first runner 112. After that, the first material A enters the channel 121 of the valve needle 12 from the first opening 122, and then the first material A is injected into the mold cavity 23 by the nozzle 114 through the sprue 24. When the first material A is injected into the mold cavity 23 in a predetermined amount, the pneumatic control device 3 transmits the gas G at a preset temperature into each of the secondary air ducts 262 through the main air duct 261 of the conformal air duct 26 and diffuses the gas G from the micropores of the mold core 25 into the mold cavity 23 whereby the surface of the first material A is solidified to form an epidermal layer A1, but the center is still in a fluid state, wherein the preset temperature of the gas G is adjusted according to the characteristics of the first material A.

When the preset amount of the first material A is injected, the valve needle 12 is controlled to move axially from the first position L1 to the second position L2, synchronously drives the first valve 124 to close the first runner 112 and synchronously drives the second valve 125 to form a dislocation with the second runner 113 such that the second opening 123 corresponds to the second runner 113. Additionally, the second heater 143 heats the second material B in the second feed tube 14 such that the second material B is in a fluid state, pushing the flowing second material B to the second runner 113 by the second pushing mechanism 142. After that, the second material B enters the channel 121 of the valve needle 12 from the second opening 123, and then the second material B is injected into the mold cavity 23 by the nozzle 114 through the sprue 24.

After the second material B is injected into the mold cavity 23, the second material B is covered by the first material A. The second material B is continuously injected into the first material A such that the first material A expands and flows to fill the end of the mold cavity 23. Moreover, in order to make the flowing first material A and the flowing second material B completely fill the mold cavity 23, The pneumatic control device 2 controls the gas in the mold cavity to pass through the micropores of the mold core 25, each of the secondary air ducts 262 and the main air duct 261 to the pneumatic control device 3 to discharge to the outside. The first material A can flow to the end of the mold cavity by the gravity of the exhaust gas. In addition, the second material B flows along with the first material A to the end of the mold cavity 23 in a coated state until it is completed filled. Further, when the second material B is a foam material, the speed of the exhaust gas can be controlled to be consistent with the speed of foaming such that the second material B can be completely foamed so as to avoid the foam being pulled into a void due to the excessive speed of the exhaust gas of the pneumatic control device 3, or avoid the foaming of the second material B being completed due to the slow speed of the exhaust gas of the pneumatic control device 3, but there is a problem of incomplete filling of the end of the mold cavity 23. Additionally, the pneumatic control device 3 controls the gas G to enter to the mold cavity 23 to bring about a back pressure effect, avoid flow marks, improve the surface appearance of the finished product and solve the problem of surface defects of the finished product.

Furthermore, after the injection process of the second material B is completed, the valve needle 12 is controlled to move axially from the second position L2 to the first position L1, synchronously drives the second valve 125 to close the second runner 113 and synchronously drives the second valve 125 to close the second runner 113 such that the first opening 122 corresponds to the first runner 112, and the first material A is re-injected into the mold cavity 23. The second material B is completely covered such that the sprue 24, the channel 121 and the nozzle 114 are cleared of the second material B and such that the second material B will not appear on the outer surface of the finished product during the next molding. In addition, after the first material A and the second material B complete the injection process, the pneumatic control device 3 can control the gas G to enter the mold cavity 23 such that the finished product can be cooled rapidly. Besides, after the first mold 21 and the second mold 23 are opened, the pneumatic control device 3 can be controlled to enter the gas such that the finished product can be pushed by the gas G to complete the demoulding process.

As mentioned above, co-injection molding plastic products have advantages of cost reduction, lightweight structure and material recycling. When foam material is used in the center of the finished product and the outer layer is a general-purpose injection plastic as a solid epidermal layer, the finished product can have the advantage of being lightweight. Generally, high-performance or special engineering plastics are more expensive, but they are still needed in some specific applications. As such, when the inner core of the finished product does not require the use of high-performance materials, co-injection molding can play its benefits. Low-cost or recycled secondary materials can be used as the filling material for the inner core while maintaining high-performance epidermal layer materials.

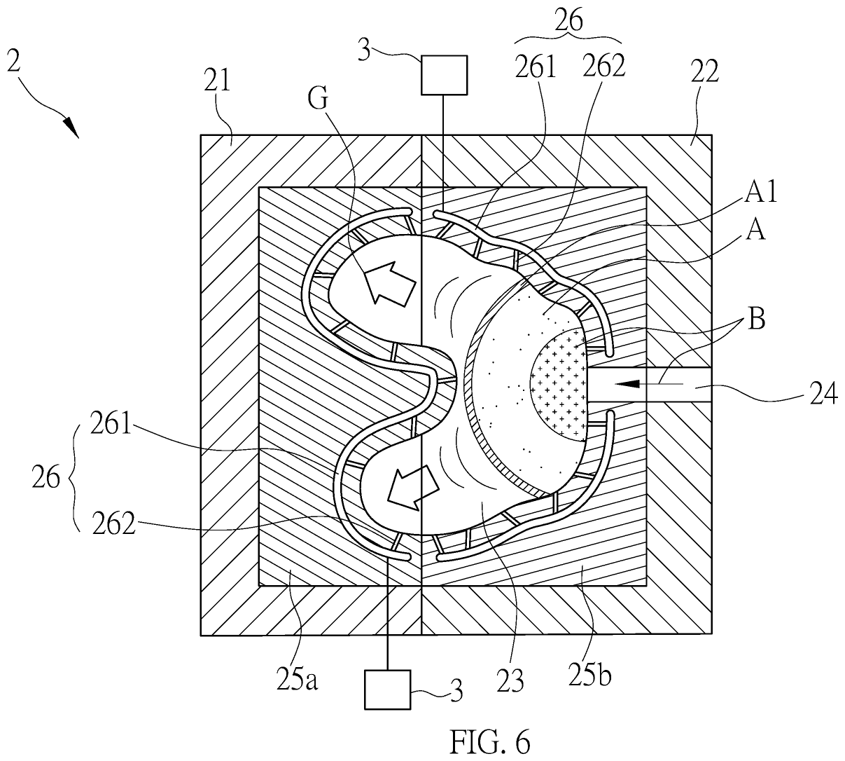

Please continue to refer to FIG. 3 to FIG. 6, when the shape of the path of the conformal air duct 26 is a straight line without a curve as shown in FIG. 3 to FIG. 5, the mold core 25 can be formed by processing the main air duct 261 and each of the secondary air ducts 262 of the conformal air duct 26 with porous steel or by 3D printing. When the mold cavity 23 and the conformal air duct 26 have multiple curves as shown in FIG. 6 and cannot be formed by processing, the mold core formed by 3D printing can meet the requirements of difficult structures. In this embodiment, the first mod core 25a and a second mold core 25b are embedded in the mold cavity 23 and respectively embedded in the first mold 21 and the second mold 22. Both the first mold core 25a and the second mold core 25b are provided with conformal air duct 26. Each of the conformal air ducts 26 has at least one main air duct 261 and a plurality of secondary air duct 262. Each of the secondary air ducts 262 is connected between the mold cavity 23 and the main air duct 261. The conformal air ducts 26 of the first mold core 25a and the second mold core 25b can be connected to a pneumatic control device 3 respectively as shown in the drawings such that the gravity generated when the pneumatic control devices 3 discharges the gas G can fill the end of the mold cavity 23 with the first material A and the second material B, thereby solving the problem of incomplete filling.

A co-injection molding structure of other aspects will be introduced below. It should be noted that in the following embodiments, elements that are the same as or similar to those in the previous embodiments are represented by the same symbols, and will not be described again. Only the differences between different embodiments will be described.

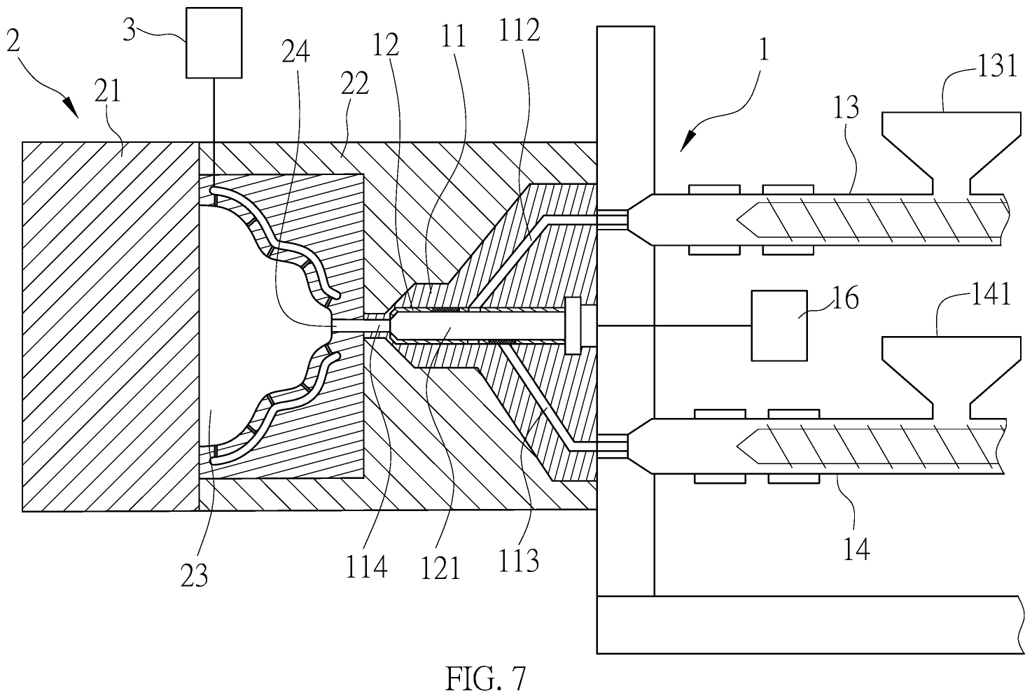

Please refer to FIG. 7, the cylinder block 11 and the valve needle 12 of the co-injection molding device 1 are arranged inside the molding die 2. In addition, the first feed tube 13 is correspondingly connected to the first runner 112 and is arranged outside the molding die 2, and the second feed tube 14 is correspondingly connected to the second runner 113 and is arranged outside the molding die 2 whereby the present disclosure can easily disassemble or assemble the first feed tube 13 or the second feed tube 14.

To sum up, by means of the co-injection molding device and the conformal air duct structure of the molding die, the co-injection molding structure of the present disclosure has the following advantages.
1. The first material (outer layer) is cooled and shaped by a gas through the pneumatic control device so as to save energy consumption.
2. The gas is controlled by the pneumatic control device to generate a back pressure in the mold cavity to avoid flow marks and improve the surface appearance of the finished product.
3. When the finished product has the same volume, the material can be greatly saved, the weight of the finished product can be reduced, the cost can be reduced, and the energy consumption can be reduced, thereby having great economic and environmental benefits.
4. The problem of incomplete filling of finished products is solved.

However, the above-mentioned embodiments are only illustrative to illustrate the effects of the present disclosure, and are not intended to limit the present disclosure. Those skilled in the art can make modifications and changes to the aforesaid embodiments without departing from the spirit and scope of the present disclosure. In addition, the numbers of elements in the above-mentioned embodiments are only for illustrative purposes, and are not intended to limit the present disclosure. Therefore, the scope of protection of rights of the present disclosure should be listed in the claims of the present disclosure below.

What is claimed is:

1. A co-injection molding structure, comprising:
a co-injection molding device, including a cylinder block, a valve needle, a first feed tube and a second feed tube, wherein an accommodating space is arranged axially inside the cylinder block, the accommodating space communicates with the outside with a first runner, a second runner and a nozzle, the valve needle is arranged in the accommodating space and is operable to reciprocate between a first position and a second position in an axial direction of the cylinder block, a channel is arranged in the axial direction of the valve needle to communicate with the nozzle, the valve needle is provided with a first opening corresponding to the first runner, a second opening corresponding to the second runner, a first valve and a second valve, the inside of the first feed tube is used to contain a first material and communicates with the first runner, the inside of the second feed tube is used to contain a second material and communicate with the second runner; and
a molding die, including a first mold and a second mold operable to be coupled or separated, wherein the first mold is coupled to the second mold to form a mold cavity, and the mold cavity has a sprue connected to the nozzle of the co-injection molding device,
whereby when the valve needle is in the first position, the second valve closes the second runner, and the first material of the first feed tube enters the channel through the first runner and the first opening and is injected into the mold cavity by the nozzle; when the valve needle is displaced from the first position to the second position, the first valve closes the first runner, and the second material of the second feed tube enters the channel through the second runner and the second opening, is injected into the mold cavity by the nozzle, is covered by the first material, and pushes the first material to flow to an end of the mold cavity.

2. The co-injection molding structure of claim 1, wherein a mold core is embedded in the mold cavity, the mold core is made of porous metal such that the inside of the mold core is covered with connected micropores, a conformal air duct is provided inside the mold core, the conformal air duct is connected with the micropores of the mold core, the conformal air duct is arranged around the mold cavity at intervals according to a shape of the mold cavity, the conformal air duct communicates with a pneumatic control device, and the pneumatic control device controls a gas to enter from the conformal air duct and diffuses to the mold cavity through the micropores of the mold core, or controls the gas in the mold cavity to be discharged from the micropores of the more core through the conformal air duct to the outside through the conformal air duct.

3. The co-injection molding structure of claim 2, wherein after the first material enters the mold cavity, the pneumatic control device controls the gas to diffuse out through the conformal air duct and the micropores of the mold core such that a surface of the first material is cooled to form an epidermal layer, and after the second material enters the mold cavity, the pneumatic control device control an exhaust gas of the mold cavity such that the flowing first material and the flowing second material are filled to an end of the mold cavity by the gravity of the exhaust gas.

4. The co-injection molding structure of claim 2, wherein the conformal air duct has a main air duct and a plurality of secondary air ducts, the main air duct is arranged around the mold cavity at an interval, and each of the secondary air ducts is connected at intervals between the mold cavity and the main air duct.

5. The co-injection molding structure of claim 2, wherein the porous metal is formed by 3D printing.

6. The co-injection molding structure of claim 3, wherein the second material is a foaming material, and the pneumatic control device is operable to make a speed of the exhaust gas consistent with a foaming speed of the foaming material such that the second material is foamed completely.

7. The co-injection molding structure of claim 1, wherein the cylinder block and the valve needle of the co-injection molding device are arranged inside the molding die, and the first feed tube and the second feed tube are arranged outside the molding die.

8. The co-injection molding structure of claim 1, wherein the cylinder block is provided with a heater, which is used to keep an interior of the cylinder block at a preset temperature, so as to maintain fluidity of the first material and the second material.
